(19) United States
(12) Patent Application Publication
(10) Pub. No.: US 2024/0426962 A1
(43) Pub. Date: Dec. 26, 2024

(54) DEVICE AND METHOD FOR OPERATING A COMMUNICATION SYSTEM

(71) Applicant: Robert Bosch GmbH, Stuttgart (DE)

(72) Inventors: Johannes Von Hoyningen-Huene, Mielkendorf (DE); Andreas Mueller, Waiblingen (DE); Heidrun Grob-Lipski, Starzach (DE)

(21) Appl. No.: 18/703,485

(22) PCT Filed: Oct. 20, 2022
(86) PCT No.: PCT/EP2022/079162

§ 371 Date: Apr. 22, 2024

(30) Foreign Application Priority Data
Oct. 27, 2021 (DE) 10 2021 212 130.6

(51) Int. Cl. G01S 5/02; H04W 64/00

(52) U.S. Cl. CPC G01S 5/0244; G01S 5/0284; H04W 64/003

(57) ABSTRACT

A device and method for operating a communication system.

### FIELD

The present invention relates to a device and a method for operating a communication system.

### BACKGROUND INFORMATION

Autonomous transport vehicles that transport goods and interact with robots are increasingly being used in today's manufacturing facilities. Accurate localization in the production plant is necessary for an efficient process. The accuracy of the localization can influence the speed of the vehicles and the minimum distance therebetween. To ensure the safe operation of autonomous vehicles, the current localization accuracy should be taken into account. If the spatially and temporally resolved localization accuracy is not known, a worst-case consideration must be used that can be guaranteed over the entire area and at all times. However, this also means that vehicles move less efficiently than would be possible in environments with high accuracy.

A method for localizing an automated motor vehicle is described in German Patent Application No. DE 10 2015 215 699 A1, wherein an achieved localization accuracy is ascertained.

### SUMMARY

One embodiment of the present invention relates to a method for operating a communication system comprising at least three communication subscribers, wherein the method comprises at least the following steps:
continuously transmitting localization signals from the localization transmitters of a localization system,
receiving the localization signals from at least two localization transmitters by means of at least one localization receiver,
ascertaining the exact reception times of the localization signals.

Advantageously, at least one additional piece of information about the localization accuracy is transmitted to the localization receiver.

According to an example embodiment of the present invention, it is provided that the current position of the localization receiver in the coordinate system of the localization system is calculated by the localization receiver based on the temporal relationship of the received localization signals.

In the event of inaccurate localization, the object to be localized can be regulated and/or controlled by the following options, wherein the list is not exhaustive:
throttling the movement speed of the object to be localized,
using further sensors to detect the surroundings of the moving object,
periodically transmitting warning messages,
adjusting the paths of the object.

In the event of accurate localization, the object to be localized can be regulated and/or controlled by the following options, wherein the list is not exhaustive:
increasing the movement speed of the object to be localized,
using further sensors to detect the surroundings of the moving object.

Advantageously, according to an example embodiment of the present invention, the current and local localization accuracy is ascertained in parallel by the localization receiver by comparing a position ascertained by the localization system with an absolute or relative reference point.

Advantageously, according to an example embodiment of the present invention, the accuracy value is transmitted together with the current position of the object to a central computing unit. The information about the localization accuracies is evaluated in the central computing unit and sent back to the localization receivers together with the localization signal.

According to an example embodiment of the present invention, it is provided that the parameters for synchronizing the localization receivers with respect to time and phase comprise one or more of the following characteristics:
phase clock reference
frame structure
time reference (the start of the frame)
frame format.

### BRIEF DESCRIPTION OF THE DRAWINGS

FIG. 1 is a schematic representation of a communication system according to an exemplary embodiment of the present invention.

FIG. 2 shows steps of a method for operating a communication system from FIG. 1.

### DETAILED DESCRIPTION OF EXAMPLE EMBODIMENTS

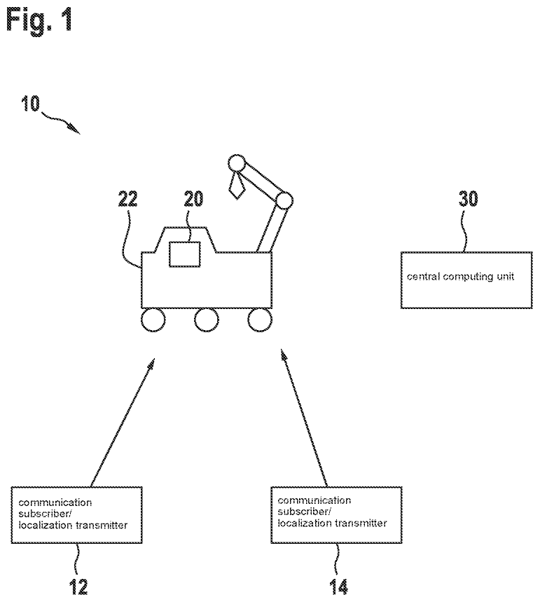

FIG. 1 schematically shows a communication system 10. The communication system is a 5G system, for example. In the exemplary embodiment, the communication system is a localization system.

By way of example, the communication system 10 comprises three communication subscribers 12, 14, 20. The two communication subscribers 12 and 14 are localization transmitters in the exemplary embodiment. The third communication subscriber 20 is designed as a localization receiver.

The localization transmitters 12, 14 periodically transmit signals that are received by the localization receiver 20 of an object 22 to be localized. However, it is also possible that the signals are periodically transmitted by the localization receiver 20 of an object 22 to be localized, and received by the localization transmitters 12, 14. For the sake of simplicity, the first case is always described below, in which the localization transmitters 12, 14 periodically transmit signals that are received by the localization receiver 20 of an object 22 to be localized, wherein all explanations also apply analogously to the case in which the signals are periodically transmitted by the localization receiver 20 of an object 22 to be localized and are received by the localization transmitters 12, 14.

The object 22 to be localized is, for example, a transport vehicle as used in production plants, for example to transport goods and/or to interact with robots and automated systems. However, it can be any other vehicle that a person skilled in the art deems appropriate.

The transmission between the communication participants 12, 14, 22 must take place within certain time windows.

Either the propagation time of the signal from the localization transmitters 12, 14 to the localization receiver 20 of an object 22 to be localized is known by means of a corresponding time measurement of the time at which a piece of information is received and a piece of time information in the localization signals. However, the difference between the propagation times of the signals of the localization transmitters 12, 14 can also be known.

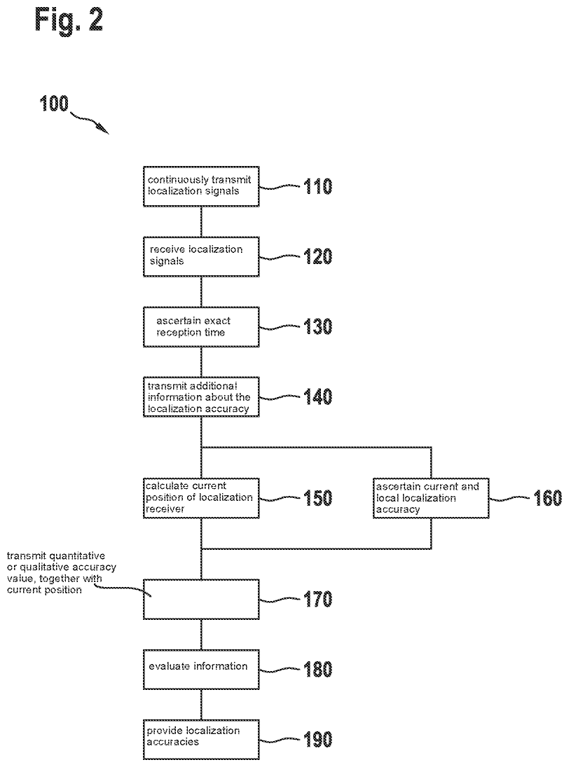

Further aspects are explained with reference to FIG. 2. The sequence of method steps shown is exemplary. The steps can also be carried out in a different order and/or sometimes simultaneously.

According to one embodiment, a method 100 for operating the communication system 10 comprises:
continuously transmitting 110 localization signals from the localization transmitters 12, 14 of the localization system 10,
receiving 120 the localization signals from at least two localization transmitters 12, 14 by means of at least one localization receiver 20,
ascertaining 130 the exact reception times.

In a further method step 140, additional information about the localization accuracy is transmitted to the localization receiver 20. Additional information can include, for example, the quality of the localization accuracy.

This information is transmitted together with the actual localization signal. Alternatively, the information is retrieved from a central computing unit 30 via at least one further communication channel.

In this way, the accuracy values can be related to a specific geometric range.

It is possible that the quality of certain localization transmitters is not high enough at a certain time to transmit reliable localization information. Then, for example, the information can be sent that the low-quality localization signals are to be taken into account with a lower weighting or not at all.

Based on the temporal relationship of the received localization signals, the current position of the localization receiver 20 in the coordinate system of the localization system 10 is calculated by the localization receiver 20 in a method step 150.

With respect to the ascertained position and the calculated localization accuracy at this location, the moving object, such as the transport vehicle 22, changes its behavior.

If the localization is inaccurate, a plurality of options may be considered, wherein the list is not exhaustive:
throttling the movement speed to avoid encountering unexpected obstacles when the vehicle is 22 in front of/behind or next to the expected position,
using additional sensors for surroundings detection: for example, cameras with image recognition, ultrasonic sensors, optical sensors and the like,
periodically transmitting warning messages to alert other vehicles in the vicinity of the current reduced localization accuracy and to avoid the risk of collision,
adjusting the paths of the vehicle 22 in such a way that locations with inaccurate localization are avoided and bypassed.

If the localization is accurate, the moving object 22 can react with the following actions, among others:
The movement speed can be increased.
Additional sensors can be used for further detection of the surroundings of the moving object 22.

In a method step 160, the current and local localization accuracy is ascertained in parallel by the localization receiver 20. The ascertainment is carried out by the position ascertained by the localization system 10 being compared to an absolute or relative reference point.

The quantitative or qualitative accuracy value ascertained in this way is transmitted to the central computing unit together with the current position in a step 170.

In the central computing unit 30, the information is evaluated in a method step 180 via the localization accuracies and combined in a type of digital map. In this case, the areas between the positions of the localization receivers that provide information are interpolated.

The localization accuracies are again provided for the localization receivers in step 190. For this purpose, the information about the localization accuracy is transmitted to the localization receivers together with the localization signal.

The parameters for synchronizing the localization receivers in a mobile radio system with respect to time and phase can comprise, for example but not exclusively, parameters of one or more of the following characteristics:
phase clock reference
frame structure
time reference (the start of the frame)
frame format.

In addition, the integration of a mobile radio network, for example 5G, into the existing industrial connectivity structure can be used to synchronize with local time domains.

The distance between localization transmitters and localization receivers is determined by the exact reception times when correcting taking into account propagation delay, information by time reference, time stamp or local time information with integrated industrial connectivity structure.

A distinction can be made between the detection of localization accuracies for stationary and moving objects.

Primarily, no localization is required for stationary objects. However, if stationary objects are equipped with a localization receiver, which in the case of a 5G system can be a standard 5G module, the localization receivers can continuously compare the current position ascertained by localization with the known setpoint of the position. The setpoint of the position can, for example, be specified by an initially calibrated value. Alternatively, a long-term average of the localization values can be used as the setpoint for the position.

By comparing the current localization value with a setpoint, a directional error value is obtained in the event that inaccuracies occur in the localization value.

Moving objects can also ascertain information about the current localization accuracy during operation. In the region of defined locations, it may be possible that the moving localization receivers are sufficiently certain about the current absolute position to be able to directly estimate the accuracy of the localization signal.

During movement, the absolute reference point that is assumed to be certain is often missing. In many cases, a transport vehicle then has relative reference values: For example, it can be assumed that a vehicle has covered a distance of X meters from a first point in time to a second point in time based on the known steering angle and the number of wheel rotations.

If the positions ascertained by the localization system have a different distance at the first and second points in time, conclusions can also be drawn about the current and local localization accuracy.

1-10. (canceled)

11. A method for operating a communication system including at least three communication subscribers, the method comprising the following steps:
continuously transmitting localization signals from localization transmitters of the localization system;
receiving the localization signals from at least two of the localization transmitters by at least one localization receiver; and
ascertaining exact reception times of the localization signals.

12. The method according to claim 11, wherein additional information about localization accuracy is transmitted to the localization receiver.

13. The method according to claim 11, wherein a current position of the localization receiver in a coordinate system of the localization system is calculated by the localization receiver based on a temporal relationship of the received localization signals.

14. The method according to claim 13, wherein an object to be localized is to be regulated and/or controlled by at least one of the following options in the event of inaccurate localization:
throttling a movement speed of the object to be localized,
using further sensors to detect surroundings of the moving object,
periodically transmitting warning messages,
adjusting paths of the object.

15. The method according to claim 13, wherein an object to be localized is to be regulated and/or controlled by at least one of the following options in the event of accurate localization:
increasing a movement speed of the object to be localized,
using further sensors to detect surroundings of the moving object.

16. The method according to claim 15, wherein a current and local localization accuracy is ascertained in parallel by the localization receiver by comparing a position ascertained by the localization system with an absolute or relative reference point.

17. The method according to claim 16, wherein an accuracy value is transmitted together with the current position of the object to a central computing unit.

18. The method according to claim 17, wherein information about the localization accuracies is evaluated in the central computing unit.

19. The method according to claim 18, wherein the information about the localization accuracy is transmitted to the localization receiver together with the localization signal.

20. The method according to claim 11, wherein parameters for synchronizing the localization receiver with respect to time and phase include one or more of the following characteristics:
phase clock reference,
frame structure,
time reference including a start of a frame,
frame format.
